(19) United States
(12) Patent Application Publication
(10) Pub. No.: US 2015/0361695 A1
(43) Pub. Date: Dec. 17, 2015

(54) Door Latch

(71) Applicants: Hyundai Motor Company, Seoul (KR); PYEONG HWA AUTOMOTIVE CO., LTD., Daegu (KR)

(72) Inventors: Sang Hyun LEE, Jeju-Si (KR); Kyung Sup Chun, Seoul (KR); Rae Ung Jeong, Daegu-si (KR)

(73) Assignees: Hyundai Motor Company, Seoul (KR); PYEONG HWA AUTOMOTIVE CO., LTD., Daegu (KR)

(21) Appl. No.: 14/531,078

(22) Filed: Nov. 3, 2014

(30) Foreign Application Priority Data
Jun. 11, 2014 (KR) 10-2014-0070764

(51) Int. Cl. E05B 85/20

(52) U.S. Cl. CPC E05B 85/20

(57) ABSTRACT

A door latch may include an engaging link engaged with a door striker and turned forward by the door striker, a locking link preventing the engaging link from turning backward by coming in contact with the engaging link, when the engaging link turns forward over a predetermined angle, and a lever disposed coaxially with the locking link and turning in conjunction with the locking link in a same direction, as a door handle is operated, wherein the locking link and the engaging link are separated from each other by the turning of the lever.

### CROSS REFERENCE TO RELATED APPLICATION

The present application claims priority to Korean Patent Application No. 10-2014-0070764, filed Jun. 11, 2014, the entire contents of which is incorporated herein for all purposes by this reference.

### BACKGROUND OF THE INVENTION

1. Field of the Invention

The present invention relates, in general, to a door latch, and, more particularly, to a door latch in which the latching sound and the strength against freezing and dust are improved.

2. Description of the Related Art

Generally, vehicles are equipped with door latches that prevent the doors of the vehicles from opening without the specific intention of passengers when the vehicles are running or when an external shock is applied, after the doors are closed by the passengers.

Disclosed was a structure of a door latch in a conventional art, which includes a body that has a path on which a striker fixed to a car body moves inside, a catch lever that is turnably fastened to the body and has a fitting groove at one side which is recessed inward and in which the striker is fitted, a first locking step at the other side which protrudes outward, and a second locking step close to the first locking step, a stop lever that is turnably fastened to the body and has a locking protrusion at one side which restricts turning of the catch lever in contact with the first locking step or the second locking step, and an inner lever that is turnably fastened to the body and turns the stop lever.

However, there is also a problem in this configuration of the conventional art in that since the turning directions of the inner lever and the stop lever are different, friction is caused at the contact point when the inner lever turns the stop lever and a passenger has to use a large force in order to open a door due to the friction, such that it is inconvenient to open/close a door. Further, there is another problem in that since the inner lever and the stop lever turn on individual axes, when an external shock is applied to a vehicle, the latch may be unfastened due to individual turning of the levers, and accordingly, a door may threaten the safety of passengers by opening regardless of intention of the passengers.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a door latch that makes it more convenient to open a door without friction by disposing a stop lever and an inner lever on the same axis and prevents a door from randomly opening regardless of intention of a passenger by absorbing some of a shock through a shaft, even if an external shock is applied.

According to various aspects of the present invention, a door latch may include an engaging link engaged with a door striker and turned forward by the door striker, a locking link preventing the engaging link from turning backward by coming in contact with the engaging link, when the engaging link turns forward over a predetermined angle, and a lever disposed coaxially with the locking link and turning in conjunction with the locking link in a same direction, as a door handle is operated, in which the locking link and the engaging link are separated from each other by the turning of the lever.

The door latch may further include a support shaft through which the locking link and the lever are coaxially combined with each other, in which the locking link and the lever may rotate on the support shaft.

The locking link may prevent the engaging link from turning backward, with a first end portion fitted on the support shaft and second end portion in contact with a back side of the engaging link.

The door latch may further include a connecting link provided between the locking link and the lever, combined with the support shaft, and transmitting a turning force of the lever to the locking link.

As the lever turns, a first end portion of the lever may come in contact with a first end portion of the connecting link and transmit the turning force to the connecting link.

The door latch may further include a locking link for selectively locking or separating the locking link and the connecting link to or from each other.

A pair of guide protrusions protruding in q radial direction of the connecting link and spaced from each other may be provided on the connecting link and a contact protrusion corresponding to q guide protrusion of the pair of guide protrusions, which is in a turning direction of the locking link by the operation of the door handle, may be provided on the locking link.

The door latch may further include a locking link sliding between the pair of spaced guide protrusions, and the locking link and the connecting link may be selectively locked or separated to or from each other by the sliding of the locking link.

When a first end portion of the locking link comes in contact with both the contact protrusion and the guide protrusion, the connecting link and the locking link may be locked to each other.

The contact protrusion may be shorter than the guide protrusion, and when the first end portion of the locking link slides out of the contact protrusion, the connecting link and the locking link may be separated from each other.

The door latch may further include a support panel formed longitudinally along another guide protrusion of the pair of guide protrusions, which does not correspond to the contact protrusion, and being in contact with the first end portion of the locking link.

The door latch may further include a stopper preventing the locking link from turning toward the engaging link by coming in contact with a surface of the second end portion of the locking link, which faces the engaging link.

When the second end portion of the locking link and the back side of the engaging link are in contact with each other, an imaginary line from a contact point to a rotational center of the locking link and an imaginary line from a contact point to a rotational center of the engaging link may be perpendicular to each other.

According to the door latch having the aforementioned structure, since the turning directions of the lever and the locking link are the same, the turning motion is not accompanied by a friction contact, so a door can be more comfortably opened.

Further, even if an external shock is applied, the shock is transmitted to the support shaft, such that it is possible to prevent turning of the lever and the locking link due to the shock.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a front view of an exemplary door latch according to the present invention.

FIG. 2 is a rear view of the exemplary door latch according to the present invention.

FIG. 3 is a right side view of the exemplary door latch according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A door latch according to various embodiments of the present invention is described hereafter with reference to the accompanying drawings.

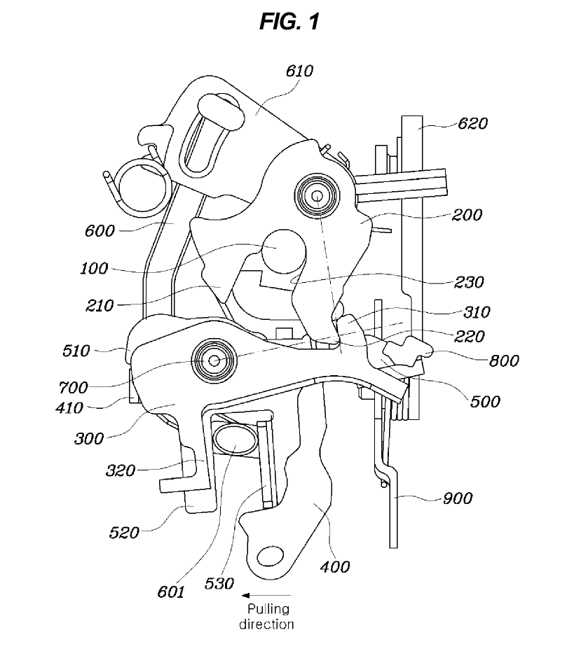

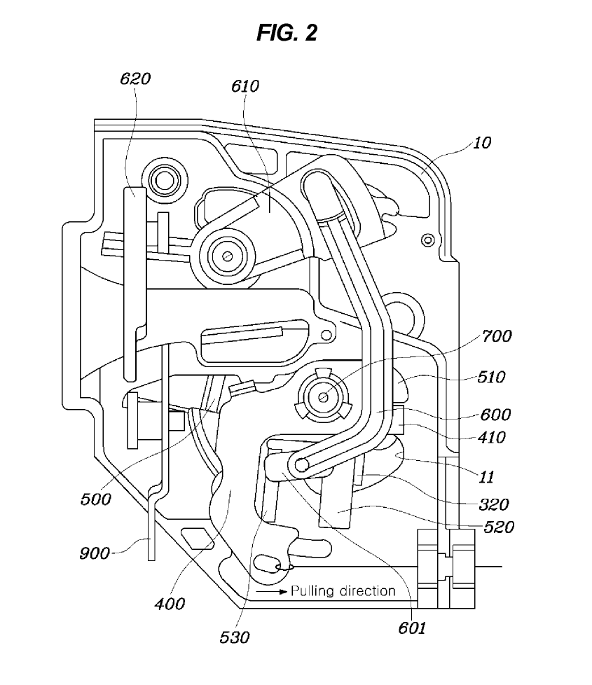

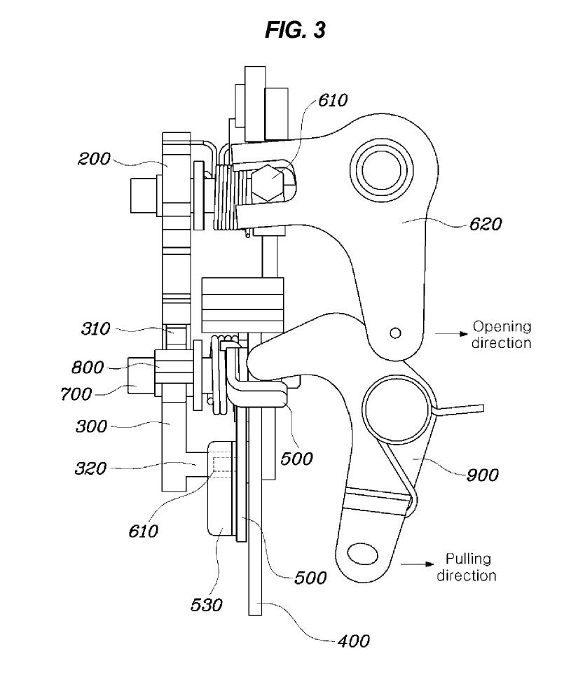

FIG. 1 is a front view of an exemplary door latch according to various embodiments of the present invention, FIG. 2 is a rear view of the door latch according to various embodiments of the present invention, and FIG. 3 is a right side view of the door latch according to various embodiments of the present invention.

A door latch according to various embodiments of the present invention include an engaging link 200 that is engaged with a door striker 100 and turned forward by the door striker 100, a locking link 300 that prevents the engaging link 200 from turning backward by coming in contact with the engaging link 200, when the engaging link 200 turns forward over a predetermined angle, and a lever 400 that is disposed coaxially with the locking link 300 and turns in conjunction with the locking link 300 in the same direction, as a door handle is operated, in which the locking link 300 and the engaging link 200 are separated from each other by turning of the lever 400.

The door handle may include both of the outer handle and the inner handle of a door.

Describing the door latch according to various embodiments of the present invention in more detail, the striker 100 may be a ring-shaped frame fastened to a door or a car body and the door latch according to various embodiments of the present invention may be disposed on a door without the striker 100 or a car body to be locked to the striker 100.

Further, a back panel 10 may be further provided to install the engaging link 200, the locking link 300, and the lever 400 and it may be disposed in the door or the car body to be able to support the engaging link 200, the locking link 300, and the lever 400.

Further, the engaging link 200 and the locking link 300 may be disposed on one side of the back panel 10 and the lever 400 may be disposed on the other side of the back panel 10, but the present invention is not limited to this configuration.

A first end portion of the engaging link 200 is hinged to one side of the back panel 10 and an insertion groove 230 where the striker 100 is inserted may be formed at a second end portion of the engaging link 200, such that as the striker 100 is inserted into the insertion groove 230 and then turned forward, the second end portion of the engaging link 200 is locked with the striker 100, and accordingly, the door is fixed. The term ‘forward’ means the direction in which the engaging link 200 turns, when the striker 100 is inserted in the insertion groove 230.

An engaging link-elastic portion 240 that turns the engaging link 200 backward may be provided at the first end portion of the engaging link 200, so the engaging link 200 is turned backward by the engaging link-elastic portion 240, when it is separated from the locking link 300, and thus, the door can open.

A support shaft 700 by which the locking link 300 and the lever 400 are coaxially combined with each other is provided and the locking link 300 and the lever 400 can turn on the support shaft 700 so that the locking link 300 can prevent the engaging link 200 from turning backward, with a first end portion fitted on the support shaft 700 and a second end portion in contact with the back side of the engaging link 200. An engaging link-elastic portion (not indicated by a reference numeral) which applies a turning force to the engaging link 200 without an external force may be further provided on the locking link 300.

The second end portion of the locking link 300 is arranged toward the striker 100 and a locking step 310 is formed at the second end portion of the locking link 300, such that the back side of the second end portion of the engaging link 200, that is, the side facing the striker 100 and the locking step 310 are brought in contact with each other, and accordingly, when the second end portion of the engaging link 200 is locked, backward turning of the engaging link 200 can be restricted.

In more detail, a first locking portion 210 and a second locking portion 220 which form both walls of the insertion groove 230 may be formed around the insertion groove 230 at the second end portion of the engaging link 200. Accordingly, when the striker 100 is inserted, the first locking portion 210 is locked first to the locking step 310, and then when the striker 100 is further inserted, the second locking portion 220 is locked to the locking step 310, such that the door is fully locked.

As described above, since the locking step 310 is arranged to come in contact with the back side of the second end portion of the engaging link 200, the locking step 310 is free from friction until it is locked to the second locking portion 220 after being locked to the first locking portion 210, thus creating the advantage that it is possible to preclude the feeling of a foreign substance due to continuous contact between the locking step 310 and the engaging link 200, with the door closed, thus making it more comfortable to close the door.

Further, the locking link 300 and the engaging link 200 may be formed such that when the second end portion of the locking link 300 and the back side of the engaging link 200 are in contact, as shown in FIG. 1, the imaginary line from the contact point to the rotational center of the locking link 300 and the imaginary line from the contact point to the rotational center of the engaging link 200 are perpendicular to each other.

The turning force for the engaging link 300 to be separated from the engaging link 200 can be minimized by this configuration, and accordingly, it is possible to more comfortably open the door.

On the other hand, a stopper 800 that prevents the locking link 300 from turning toward the engaging link 200 by coming in contact with the surface of the second end portion of the locking link 300, which faces the engaging link 200, may be further provided on one side of the back panel 10.

Since the stopper 800 is disposed to come in contact with the surface of the second end portion of the locking link 300, which faces the engaging link 200, it is possible to prevent foreign substances from accumulating on the stopper 800, with the engaging link 200 and the locking link 300 arranged in an up and down manner. When foreign substances such as dust accumulate on the stopper 800, the locking step 310 and the engaging link 200 are not completely fastened, such that when an external shock is applied, the locking step 310 may be separated from the engaging link 200 due to the shock. Accordingly, the mechanism of this design has the advantage of reduced malfunction by preventing foreign substances from accumulating on the stopper 800.

On the other hand, as shown in FIG. 2, a connecting link 500 that is combined with the support shaft 700 and transmits the turning force of the lever 400 to the locking link 300 may be further provided between the locking link 300 and the lever 400. In detail, the connecting link 500 may be disposed between the back panel 10 and the lever 400, on the other side of the back panel 10.

The connecting link 500 and the lever 400 can freely turn about the support shaft 700, with the support shaft 700 through the ends of the connecting link 500 and the lever 400, and as the lever 400 turns, the end portion 410 of the lever 400 comes in contact with the end portion 510 of the connecting link 500, such that the turning force can be transmitted to the connecting link 500.

To this end, the end portion 510 of the connecting link 500 may be positioned forward in the turning direction further than the end portion 410 of the lever 400, such that it is possible to turn the locking link 300 by turning a second end portion of the connecting link 500 even without turning the lever 400.

That is, a specific opening lever 900, for example, an opening lever 900 connected with the inner handle of the door may be provided, with the lever 400 connected with the outer handle of the door so that as the inner handle is operated, the opening lever 900 turns to turn the other end of the connecting link 500. Accordingly, it is possible to operate both of the outer handle and the inner handle simultaneously with the locking link 300, using the connecting link 500, even without a specific link that operates the inner handle and the locking link 300 simultaneously. Therefore, the mechanism described above has the advantage of requiring a reduced number of parts and the size of the door latch can thus be reduced. Not the outer handle, but the inner handle may be connected with the lever 400.

Additionally, a locking link 600 that selectively locks or separates the locking link 300 and the connecting link 500 to or from each other may be further provided.

In more detail, a pair of guide protrusions 520 that protrude in the radial direction of the connecting link 500 and are spaced from each other may be provided on the connecting link 500 and a contact protrusion 320 corresponding to the guide protrusion 520, which is in the turning direction of the locking link 300 by the operation of the door handle, of the pair of guide protrusions 520 may be provided on the locking link 300.

Further, the locking link 600 slides between the pair of spaced guide protrusions 520, such that when the first end portion of the locking link 600 comes in contact with both the contact protrusion 320 and the guide protrusion 520, the connecting link 500 and the locking link 300 are locked and they are turned together, when the connecting link 500 turns.

The contact protrusion 320 may be shorter than the guide protrusion 520, extending toward the guide protrusion 520, but since there is the back panel 10 between the connecting link 500 and the locking link 300, an oblong hole 11 through which the contact protrusion 320 passes may be formed at the back panel 10 along the movement path of the contact protrusion 320 so that the contact protrusion 320 can extend toward the guide protrusion 520 through the back panel 10 and come in contact with the first end portion of the locking link 600.

When the first end portion of the connecting link 500 slides out of the contact protrusion 320, only the locking link 500 turns, such that the connecting link 500 and the locking link 300 can be separated. That is, the locking link 300 does not turn, even though the door handle is operated.

A sliding protrusion 601 may be formed at the first end portion of the locking link 600 to be able to slide between the pair of guide protrusions 520 and come in contact with the contact protrusion 320. Further, the first end portion of the locking link 600 may bend and slide between the pair of guide protrusions 520. Obviously, the present invention is not limited to this configuration and may be modified in various ways in accordance with intention of the designers.

On the other hand, at the other guide protrusion 520 not corresponding to the contact protrusion 320 of the pair of guide protrusions 520, a support panel 530 that is formed longitudinally along the guide protrusion 520 in contact with the first end portion of the locking link 600 may be provided.

The support panel 530 may be formed by bending the guide protrusion 520 or may be separately provided and bonded to the guide protrusion 520.

By the support panel 530, it is possible to increase the contact area between the first end portion of the locking link 600 and the connecting link 500 even without increasing the thickness of the locking link 500, such that the turning force of the connecting link 500 can be transmitted to the locking link 300 through the contact protrusion 320.

The locking link 600 operates in conjunction with a locking button on the door and moves along the guide protrusion 520 with the operation of the locking button for locking or opening the door. To this end, a locking lever 620 turning with the operation of the locking button is provided, and as shown in FIG. 3, an interlocking link 610, which has a first end portion locked to the locking lever 620 and a second end portion locked to the second end portion of the locking link 600, and which moves the locking link 600, as the locking lever 620 turns, may be provided.

The connecting link 500, the lever 400, the opening lever 900, the locking lever 620, and the interlocking link 610 all have an elastic portion and the elastic portions may apply a return turning force to their links or levers in the opposite directions to the turning directions, when the door handle is operated.

Further, the lever 400, the opening lever 900, and the locking lever 620 may be connected with the door handle and the locking button by wires and operated together.

According to the door latch having the structure described above, since the turning directions of the lever 400 and the locking link 300 are the same, the friction force when the turning force is transmitted is reduced, such that a door can be more comfortably opened.

Further, even if an external shock is applied, the support shaft absorbs the shock, such that it is possible to prevent the lever 400 and the locking link 300 from turning due to the shock and to prevent a door from opening which is not intended by a passenger.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A door latch comprising:
an engaging link engaged with a door striker and turned forward by the door striker;
a locking link preventing the engaging link from turning backward by coming in contact with the engaging link, when the engaging link turns forward over a predetermined angle; and
a lever disposed coaxially with the locking link and turning in conjunction with the locking link in a same direction, as a door handle is operated,
wherein the locking link and the engaging link are separated from each other by the turning of the lever.

2. The door latch of claim 1, further comprising a support shaft through which the locking link and the lever are coaxially combined with each other, wherein the locking link and the lever rotate on the support shaft.

3. The door latch of claim 2, wherein the locking link prevents the engaging link from turning backward, with a first end portion fitted on the support shaft and a second end portion in contact with a back side of the engaging link.

4. The door latch of claim 2, further comprising a connecting link provided between the locking link and the lever, the connecting link combined with the support shaft and transmitting a turning force of the lever to the locking link.

5. The door latch of claim 4, wherein as the lever turns, a first end portion of the lever comes in contact with a first end portion of the connecting link and transmits the turning force to the connecting link.

6. The door latch of claim 4, further comprising a locking link for selectively locking or separating the locking link and the connecting link to or from each other.

7. The door latch of claim 4, wherein a pair of guide protrusions protruding in a radial direction of the connecting link and spaced from each other are provided on the connecting link and a contact protrusion corresponding to a guide protrusion of the pair of guide protrusions, which is in a turning direction of the locking link by the operation of the door handle, is provided on the locking link.

8. The door latch of claim 7, further comprising a locking link sliding between the pair of spaced guide protrusions, wherein the locking link and the connecting link are selectively locked or separated to or from each other by the sliding of the locking link.

9. The door latch of claim 8, wherein when a first end portion of the locking link comes in contact with both the contact protrusion and the guide protrusion, the connecting link and the locking link are locked to each other.

10. The door latch of claim 8, wherein the contact protrusion is shorter than the guide protrusion, and when the first end portion of the locking link slides out of the contact protrusion, the connecting link and the locking link are separated from each other.

11. The door latch of claim 8, further comprising a support panel formed longitudinally along another guide protrusion of the pair of guide protrusions, which does not correspond to the contact protrusion, and being in contact with the first end portion of the locking link.

12. The door latch of claim 3, further comprising a stopper preventing the locking link from turning toward the engaging link by coming in contact with a surface of the second end portion of the locking link, which faces the engaging link.

13. The door latch of claim 3, wherein when the second end portion of the locking link and the back side of the engaging link are in contact with each other, an imaginary line from a contact point to a rotational center of the locking link and an imaginary line from a contact point to a rotational center of the engaging link are perpendicular to each other.
